(19) United States
(12) Patent Application Publication
(10) Pub. No.: US 2024/0289792 A1
(43) Pub. Date: Aug. 29, 2024

(54) SYSTEMS AND METHODS FOR NEAR FIELD CONTACTLESS CARD COMMUNICATION AND CRYPTOGRAPHIC AUTHENTICATION

(71) Applicant: Capital One Services, LLC, McLean, VA (US)

(72) Inventors: Jeffrey RULE, Chevy Chase, MD (US); Gaurang BHATT, Herndon, VA (US); Lukiih CUAN, Washington, DC (US); Rocky GUO, Falls Church, VA (US)

(21) Appl. No.: 18/430,727

(22) Filed: Feb. 2, 2024

Related U.S. Application Data
(63) Continuation of application No. 18/076,235, filed on Dec. 6, 2022, now Pat. No. 11,922,417.
Application No. 18/076,235 is a continuation of application No. 17/161,424, filed on Jan. 28, 2021, now Pat. No. 11,562,358.

(51) Int. Cl. G06Q 20/40; G06Q 20/32; G06Q 20/34; G06Q 20/38

(52) U.S. Cl. CPC G06Q 20/401; G06Q 20/3278; G06Q 20/352; G06Q 20/38215; G06Q 2220/00

(57) ABSTRACT

Systems and methods for authentication may include an authentication server. The authentication server may include a processor and a memory. The processor may be configured to receive a cryptogram associated with a first near field communication data exchange format (NDEF) read. The processor may be configured to perform a first factor authentication of the cryptogram. The processor may be configured to receive a first data set, wherein the first data set is associated with a second NDEF read. The processor may be configured to extract metadata from the first data set. The processor may be configured to perform, after the first factor authentication, a second factor authentication based on the metadata. The processor may be configured to generate a message indicative of an outcome of the second factor authentication. The processor may be configured to transmit the message that instructs the processor to effectuate one or more actions.

### CROSS-REFERENCE TO RELATED APPLICATIONS

This application is a continuation of U.S. patent application Ser. No. 18/076,235, filed Dec. 6, 2022, which is a continuation of U.S. patent application Ser. No. 17/161,424, filed Jan. 28, 2021 (now U.S. Pat. No. 11,562,358), the disclosures of which are incorporated herein by reference in their entireties.

### FIELD OF THE DISCLOSURE

The present disclosure relates to systems and methods for contactless card communication and, more specifically, for near field communication and cryptographic authentication of contactless cards.

### BACKGROUND

Card-based operations have many data points stored in its chip that may be sent to a device in communication with the card upon a card swipe or other data transfer. These operations often involve the use of a card in communication with a point of sale (POS) device, a server, or other device, which may also send information back to the card. It is necessary to protect such communications from interception and unauthorized access.

However, transmission of data without encryption or other protection is susceptible to interception, replay and other attacks, and may be subject to other vulnerabilities, resulting in increased security risks and increased risks of account or card misuse. These risks may be further increased through the use of contactless cards, which communicate with other devices wirelessly.

Measures taken to address security risk may consume system resources and hinder operational efficiency. For large numbers of operations, the consumption of system resources and the hindrance of operation efficiency can increase, which may result in a failure to perform operations or unsatisfactory performance.

These and other deficiencies exist. Accordingly, there is a need for systems and methods for authentication that overcome these deficiencies by protecting communications from interception and unauthorized access in a secure and reliable manner.

### SUMMARY OF THE DISCLOSURE

Embodiments of the present disclosure provide an authentication server. The authentication server may include a processor and a memory. The processor may be configured to receive a cryptogram associated with a first near field communication data exchange format (NDEF) read. The processor may be configured to perform a first factor authentication of the cryptogram. The processor may be configured to receive a first data set, wherein the first data set is associated with a second NDEF read. The processor may be configured to extract metadata from the first data set. The processor may be configured to perform, after the first factor authentication, a second factor authentication based on the metadata. The processor may be configured to generate a message indicative of an outcome of the second factor authentication. The processor may be configured to transmit the message that instructs the processor to effectuate one or more actions.

Embodiments of the present disclosure provide a method of authentication. The method may include receiving a cryptogram associated with a first near field communication data exchange format (NDEF) read. The method may include performing a first factor authentication. The method may include receiving a first data set, wherein the first data set is associated with a second NDEF read. The method may include extracting metadata from the first data set. The method may include performing, after the first factor authentication, a second factor authentication based on the metadata. The method may include generating a message indicative of an outcome of the second factor authentication. The method may include transmitting the message that instructs the processor to effectuate one or more actions.

Embodiments of the present disclosure provide a computer readable non-transitory medium comprising computer executable instructions that, when executed on a processor, perform procedures comprising the steps of: receiving a cryptogram associated with a first near field communication data exchange format (NDEF) read; performing a first factor authentication; receiving a first data set, wherein the first data set is associated with a second NDEF read; extracting metadata from the first data set; performing, after the first factor authentication, a second factor authentication based on metadata; performing, after the second factor authentication, a third factor authentication by generating one or more prompts associated with one or more queries; transmitting, via one or more notifications, the one or more prompts; receiving input responsive to the one or more queries; authenticating the input; and converting, after authenticating the input, a first type of operation to a second type of operation.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts an authentication system according to an exemplary embodiment.

FIG. 2A is an illustration of a contactless card according to an exemplary embodiment.

FIG. 2B is an illustration of a contact pad of a contactless card according to an exemplary embodiment.

FIG. 3 depicts an authentication method according to an exemplary embodiment.

FIG. 4 depicts a sequence diagram of an authentication process according to an exemplary embodiment.

FIG. 5 depicts an authentication method according to an exemplary embodiment.

FIG. 6 depicts an authentication method according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The systems and methods disclosed herein convert a card-not-present transaction to a card-present transaction, which results in reduced risk and lower fraud rate. The card-not-present transaction may be created based on a variety of input parameters, including but not limited to primary account number, card verification value, and expiration date. Upon entry into a communication field of a device, the card may be authenticated via first factor authentication and also configured to transmit a first data set to an application comprising instructions for execution on the device for second factor authentication in order to convert a first type of operation to a second type of operation. This may be accomplished by reading data from the card for the last several transactions, which would be compared by a server with data stored or otherwise accessible on known transactions. In addition, the application may be configured to ask the user one or more questions for answers as a third factor authentication. In this manner, multi-factor authentication may be utilized to protect communications that are susceptible to phishing and replay attacks, thereby mitigating security risks and risks of account or card misuse.

Benefits of the systems and methods disclosed herein include improved authentication by protecting communications from interception and unauthorized access. The systems and methods disclosed herein allow for the avoidance of data interception, phishing attacks, and replay attacks through encrypted data communications, and the reduction of other security vulnerabilities.

In addition, numerous authentication factors may be performed and customized queries may be transmitted via prompts to improve authentication. By doing so, security risks can be further mitigated and transaction efficiency can be improved.

These features can be implemented without degrading the user experience by burdening the user with unnecessary security tasks. Further, these features can be performed in a manner that allows for the time-efficient performance of transactions, in order to comply with user expectations and transaction requirements.

Accordingly, the systems and methods disclosed herein reduce the risk of fraudulent activity, such as misuse of the card or an account associated with the card. Systems and methods disclosed herein improve upon implementations that lack secure authentication. These benefits may be advantageously achieved while promoting system efficiency and avoiding degradation of the user experience.

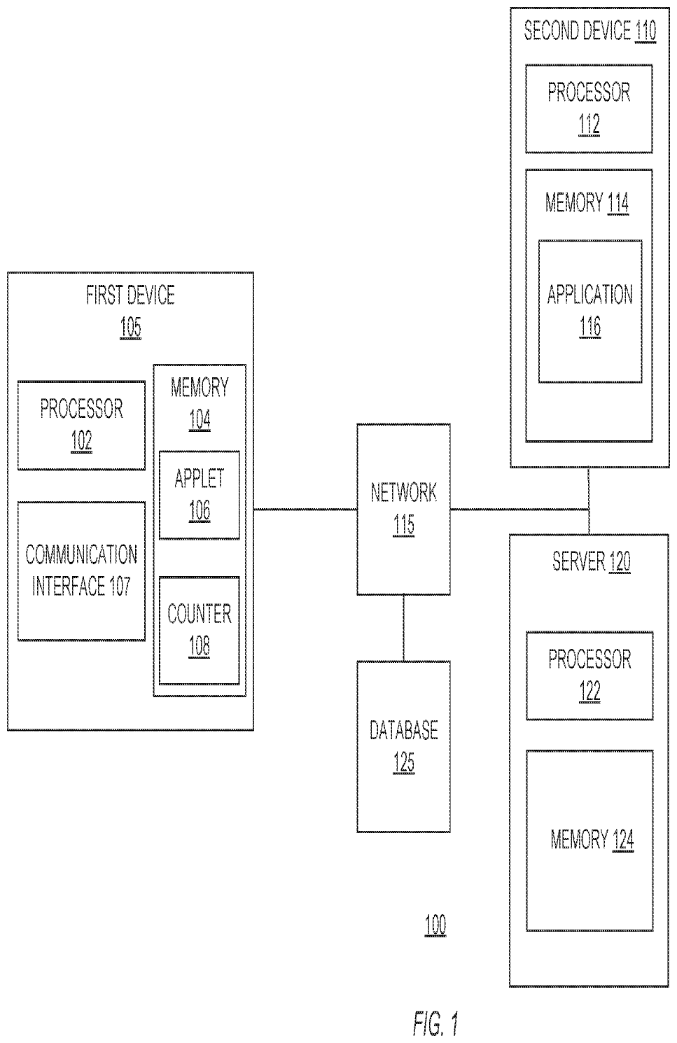

FIG. 1 illustrates an authentication system 100. The system 100 may comprise a first device 105, a second device 110, a network 115, a server 120, and a database 125. Although FIG. 1 illustrates single instances of components of system 100, system 100 may include any number of components.

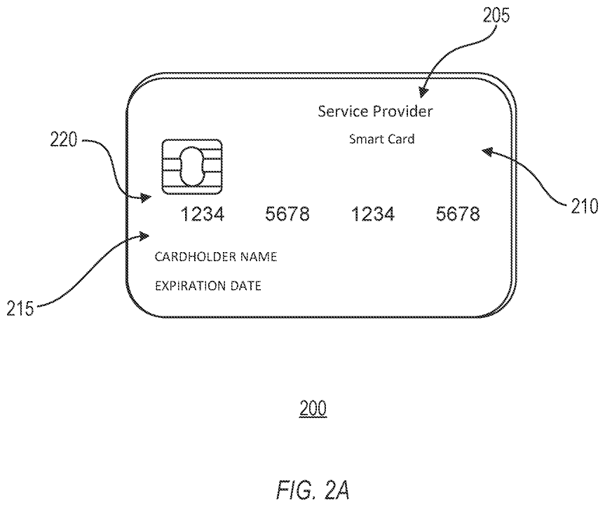

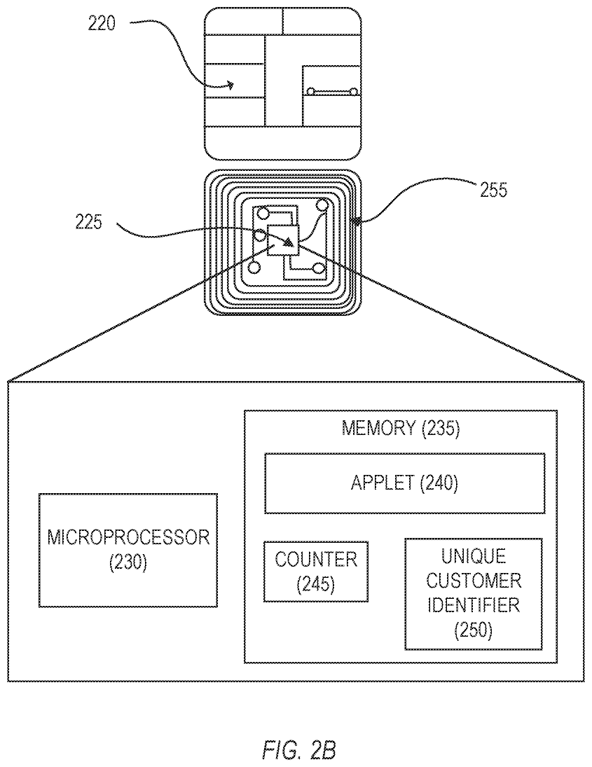

System 100 may include a first device 105. The first device 105 may comprise a contactless card, a contact-based card, a network-enabled computer, or other device described herein. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, or other device. As further explained below in FIGS. 2A-2B, first device 105 may include one or more processors 102, and memory 104. Memory 104 may include one or more applets 106 and one or more counters 108. Each counter 108 may include a counter value. Memory 104 may include the counter value, transmission data, and at least one key.

First device 105 may include a communication interface 107. The communication interface 107 may comprise communication capabilities with physical interfaces and contactless interfaces. For example, the communication interface 107 may be configured to communicate with a physical interface, such as by swiping through a card swipe interface or inserting into a card chip reader found on an automated teller machine (ATM) or other device configured to communicate over a physical interface. In other examples, the communication interface 107 may be configured to establish contactless communication with a card reading device via a short-range wireless communication method, such as NFC, Bluetooth, Wi-Fi, RFID, and other forms of contactless communication. As shown in FIG. 1, the communication interface 107 may be configured to communicate directly with the second device 110, server 120, and/or database 125 via network 115.

First device 105 may be in data communication with any number of components of system 100. For example, first device 105 may transmit data via network 115 to second device 110, and/or server 120. First device 105 may transmit data via network 115 to database 125. In some examples, first device 105 may be configured to transmit data via network 115 after entry into one or more communication fields of any device. Without limitation, each entry may be associated with a tap, a swipe, a wave, and/or any combination thereof.

System 100 may include a second device 110. The second device 110 may include one or more processors 112, and memory 114. Memory 114 may include one or more applications, including but not limited to application 116. Second device 110 may be in data communication with any number of components of system 100. For example, second device 110 may transmit data via network 115 to server 120. Second device 110 may transmit data via network 115 to database 125. Without limitation, second device 110 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, or other device. Second device 110 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The second device 110 may include processing circuitry and may contain additional components, including processors, memories, error and parity/CRC checkers, data encoders, anticollision algorithms, controllers, command decoders, security primitives and tamperproofing hardware, as necessary to perform the functions described herein. The second device 110 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include a network 115. In some examples, network 115 may be one or more of a wireless network, a wired network or any combination of wireless network and wired network, and may be configured to connect to any one of components of system 100. For example, first device 105 may be configured to connect to server 120 via network 115. In some examples, network 115 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 115 may include, without limitation, telephone lines, fiber optics, IEEE Ethernet 902.3, a wide area network, a wireless personal area network, a LAN, or a global network such as the Internet. In addition, network 115 may support an Internet network, a wireless communication network, a cellular network, or the like, or any combination thereof. Network 115 may further include one network, or any number of the exemplary types of networks mentioned above, operating as a stand-alone network or in cooperation with each other. Network 115 may utilize one or more protocols of one or more network elements to which they are communicatively coupled. Network 115 may translate to or from other protocols to one or more protocols of network devices. Although network 115 is depicted as a single network, it should be appreciated that according to one or more examples, network 115 may comprise a plurality of interconnected networks, such as, for example, the Internet, a service provider's network, a cable television network, corporate networks, such as credit card association networks, and home networks.

System 100 may include one or more servers 120. In some examples, server 120 may include one or more processors 122 coupled to memory 124. Server 120 may be configured as a central system, server or platform to control and call various data at different times to execute a plurality of workflow actions. Server 120 may be configured to connect to first device 105. Server 120 may be in data communication with the applet 106 and/or application 116. For example, a server 120 may be in data communication with applet 106 via one or more networks 115. First device 105 may be in communication with one or more servers 120 via one or more networks 115, and may operate as a respective front-end to back-end pair with server 120. First device 105 may transmit, for example from applet 106 executing thereon, one or more requests to server 120. The one or more requests may be associated with retrieving data from server 120. Server 120 may receive the one or more requests from first device 105. Based on the one or more requests from applet 106, server 120 may be configured to retrieve the requested data. Server 120 may be configured to transmit the received data to applet 106, the received data being responsive to one or more requests.

In some examples, server 120 can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server 120, it is understood that other embodiments can use multiple servers or multiple computer systems as necessary or desired to support the users and can also use back-up or redundant servers to prevent network downtime in the event of a failure of a particular server.

Server 120 may include an application comprising instructions for execution thereon. For example, the application may comprise instructions for execution on the server 120. The application of the server 120 may be in communication with any components of system 100. For example, server 120 may execute one or more applications that enable, for example, network and/or data communications with one or more components of system 100 and transmit and/or receive data. Without limitation, server 120 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. Server 120 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include processing circuitry and may contain additional components, including processors, memories, error and parity/CRC checkers, data encoders, anticollision algorithms, controllers, command decoders, security primitives and tamperproofing hardware, as necessary to perform the functions described herein. The server 120 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include one or more databases 125. The database 125 may comprise a relational database, a non-relational database, or other database implementations, and any combination thereof, including a plurality of relational databases and non-relational databases. In some examples, the database 125 may comprise a desktop database, a mobile database, or an in-memory database. Further, the database 125 may be hosted internally by any component of system 100, such as the first device 105 or server 120, or the database 125 may be hosted externally to any component of the system 100, such as the first device 105 or server 120, by a cloud-based platform, or in any storage device that is in data communication with the first device 105 and server 120. In some examples, database 125 may be in data communication with any number of components of system 100. For example, server 120 may be configured to retrieve the requested data from the database 125 that is transmitted by applet 106. Server 120 may be configured to transmit the received data from database 125 to applet 106 via network 115, the received data being responsive to the transmitted one or more requests. In other examples, applet 106 may be configured to transmit one or more requests for the requested data from database 125 via network 115.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the first device 105, second device 110, server 120, and/or database 125, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

The application 116 of the client device 110 may be configured to conduct one or more reads of a card 105 as part of a first factor authentication. For example, the application 116 may be configured to conduct a read, such as a near field communication read, of a tag, such as a near field communication tag, of the card 105. The card 105 may be configured to transmit a cryptogram. For example, the card 105 may be configured to transmit, after entry into one or more communication fields of any device, data responsive to the read, such as a first read, via a communication interface 107 of the card 105. In some examples, the card 105 may be configured to transmit, after a first entry into a first communication field of the device 110, the cryptogram. Without limitation, each entry may be associated with a tap, a swipe, a wave, and/or any combination thereof. The application 116 of the client device 110 may be configured to receive the cryptogram transmitted by the card 105. The cryptogram may be generated based on a first read of the tag of the card 105. For example, the cryptogram may be obtained via a near field communication data exchange format (NDEF) read. In some examples, the card 105 may be configured to encrypt the cryptogram prior to its transmission.

The application 116 of the client device 110 may be configured to transmit the cryptogram that it received from the card 105 to a server 120. In some examples, the server 120 may be configured to receive the cryptogram transmitted by the card 105. The server 120 may be configured to decrypt the cryptogram as part of the first factor authentication. In other examples, the application 116 of the client device 110 may be configured to decrypt the cryptogram as part of the first factor authentication.

The server 120 may be configured to transmit one or more messages to the application 116 of the client device 110. For example, one of the messages may comprise an indication of authentication status of the cryptogram. For example, the server 120 may be configure to transmit a message to the application 116 of the client device 110 that is indicative of authentication validation, such as a successful authentication status of the cryptogram. To the extent that the server 120 is unable to authenticate the cryptogram, the server 120 may be configured to transmit a message indicative of an unsuccessful authentication status of the cryptogram. If the cryptogram is not successfully authenticated, the server 120 may be configured to instruct, via one or more commands, the client application 116 of the client device 110 to re-read the tag of the card 105 to receive the cryptogram. In this manner, the server 120 may be configured to decrypt the cryptogram as part of the first factor authentication.

The application 116 of the device 110 may be configured to receive the one or more messages from the server 120. The application 116 of the device 110 may be configured to perform, after the first factor authentication, another read. For example, the application 116 of the device 110 may be configured to perform a second read of the card 105. The card 105 may be configured to transmit, after the second read, a first data set. For example, the first data set may be obtained via the second read, such as a near field communication data exchange format (NDEF) read. The first data set may be transmitted by the card 105 to the application 116 of the client device 110 via the second read. The first data set may comprise one or more sets of prior data. Without limitation, the first data set may include data for the last three transactions, such as an identifier associated with the first data set, a type of first data set, method of entry into the communication field, time stamp, and amount. The second read may be associated with one or more gestures, including but not limited to a tap, a swipe, or a wave, that represent any number of entries of a communication interface 107 of the card 105 into a communication field of the device.

Prior to performance of a second factor authentication, the application 116 of the client device 110, or server 120, may be configured to extract metadata from the first data set. The metadata may be extracted from the first device 105. In some examples, the second factor authentication may include authentication of metadata. For example, the second factor authentication may comprise authentication of metadata of the first device 105, such as the card. In some examples, the metadata belonging to the first device 105 may be personalized at the time of creation of first device 105, for example by the issuer. The metadata of first device 105 may be customized such that it is populated to include, without limitation, a plurality of fields comprising one or more prior transactions (including merchant and transaction data for a predetermined number of transactions, e.g., five transactions), one or more transaction date stamps and/or time stamps, one or more phone numbers, one or more addresses, and/or combination thereof and/or any other personally identifiable information that is capable of being authenticated. In some examples, the mobile phone number associated with the user or account may be read from the first device 105, and a second factor authentication may be transmitted to application 116 of client device 110. For example, the second factor authentication may comprise a short message system one-time password received by application 116 of client device 110.

The application 116 of the client device 110 may be configured to perform a second factor authentication. For example, the one or more sets of prior data may be evaluated against one or more reference sets of prior data as part of the second factor authentication. In other examples, the application 116 of the client device 110 may be configured to transmit the first data set to the server 120 for evaluation as part of the second factor authentication. The application 116 of the client device 110 may be configured to generate an outcome of the second factor authentication by comparing the one or more sets of prior data to one or more reference sets of prior data. Based on the outcome of the second factor authentication, the application 116 of the client device 110 may be configured to generate and display one or more messages that are indicative of the outcome of the second factor authentication.

The application 116 of the client device 110 may be configured to perform a third factor authentication. The third factor authentication may be performed prior to conversion of a first type of operation to a second type of operation by the application 116 of the client device 110. In other examples, the server 120 or application 116 of the client device 110 may be configured to generate, transmit and/or receive one or more messages indicative of the outcome of the second factor authentication. For example, at least one of the messages may be configured to instruct the application 116 or server 120 to effectuate one or more actions. The one or more actions may include conversion of the first type of operation to a second type of operation. For example, the first type of operation may comprise a card-not-present transaction. The second type of operation may comprise a card-present transaction. In this manner, the conversion may allow for improved security by indicating that the card was present for performing one or more operations, such as capturing a communication with card readers, contactless or contact-enabled terminals. In this manner, the conversion from the first type of operation to the second type of operation may be dependent on the outcome, such as the successful outcome, of the second factor authentication, since the first device 105 will be have been proven to be in physical possession of the user, thereby distinguishing between a card-present transaction and a card-not-present transaction. Moreover, the third factor authentication may be performed after the second factor authentication. For example, the application 116 of the client device 110 may be configured to perform the third factor authentication by generating one or more prompts that are transmitted via one or more notifications. In some examples, the third factor authentication may be performed by prompting, via the one or more notifications, input that is responsive to one or more queries.

Without limitation, the one or more queries may include at least one selected from the group of a primary account number, cardholder identifier such as first name, middle name, last name, a type of operation, a date, a nationality of the cardholder, a cardholder language, an address, a date of birth, an email, a telephone number, an expiration date, a credit card number, a debit card number, and/or any combination thereof. Moreover, the one or more queries may include a request for a partial portion, including but not limited to a redacted portion, of any number of these queries. The one or more queries may resemble knowledge-based authentication that form the basis of the third factor authentication.

The application 116 of the client device 110 may be configured to receive input that is responsive to the one or more queries. For example, the input to the one or more queries may include a response that includes an answer as to how many times the user shopped at a particular merchant, or conducted an operation with a specified reader or terminal, within a time frame. In another example, the input to the one or more queries may include a response that includes an answer as to how many items were associated with the most recent purchase. In another example, the input to the one or more queries may include a response that includes an amount spent associated with the most recent purchase. In another example, the input to the one or more queries may include a response that includes an answer as to a location and/or an identity of the last two transactions.

FIG. 2A illustrates one or more first devices 200. First device 200 may reference the same or similar components of first device 105, as explained above with respect to FIG. 1. Although FIGS. 2A and 2B illustrate single instances of components of first device 200, any number of components may be utilized.

First device 200 may be configured to communicate with one or more components of system 100. First device 200 may comprise a contact-based card or contactless card, which may comprise a payment card, such as a credit card, debit card, or gift card, issued by a service provider 205 displayed on the front or back of the contactless card 200. In some examples, the contactless card 200 is not related to a payment card, and may comprise, without limitation, an identification card, a membership card, and a transportation card. In some examples, the payment card may comprise a dual interface contactless payment card. The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, including but not limited to a user device, smart phone, laptop, desktop, or tablet computer. The contactless card 200 may also include processing circuitry, antenna and other components not shown in FIG. 2A. These components may be located behind the contact pad 220 or elsewhere on the substrate 210. The contactless card 200 may also include a magnetic strip or tape, which may be located on the back of the card (not shown in FIG. 2A).

As illustrated in FIG. 2B, the contact pad 220 of FIG. 2A may include processing circuitry 225 for storing and processing information, including a processor 230, such as a microprocessor, and a memory 235. It is understood that the processing circuitry 225 may contain additional components, including processors, memories, error and parity/CRC checkers, data encoders, anticollision algorithms, controllers, command decoders, security primitives and tamperproofing hardware, as necessary to perform the functions described herein.

The memory 235 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 235 may be configured to store one or more applets 240, one or more counters 245, and a customer identifier 250. The one or more applets 240 may comprise one or more software applications configured to execute on one or more contactless cards, such as Java Card applet. However, it is understood that applets 240 are not limited to Java Card applets, and instead may be any software application operable on contactless cards or other devices having limited memory. The one or more counters 245 may comprise a numeric counter sufficient to store an integer. The customer identifier 250 may comprise a unique alphanumeric identifier assigned to a user of the contactless card 200, and the identifier may distinguish the user of the contactless card from other contactless card users. In some examples, the customer identifier 250 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the contact pad 220 or entirely separate from it, or as further elements in addition to processor 230 and memory 235 elements located within the contact pad 220.

In some examples, the contactless card 200 may comprise one or more antennas 255. The one or more antennas 255 may be placed within the contactless card 200 and around the processing circuitry 225 of the contact pad 220. For example, the one or more antennas 255 may be integral with the processing circuitry 225 and the one or more antennas 255 may be used with an external booster coil. As another example, the one or more antennas 255 may be external to the contact pad 220 and the processing circuitry 225.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

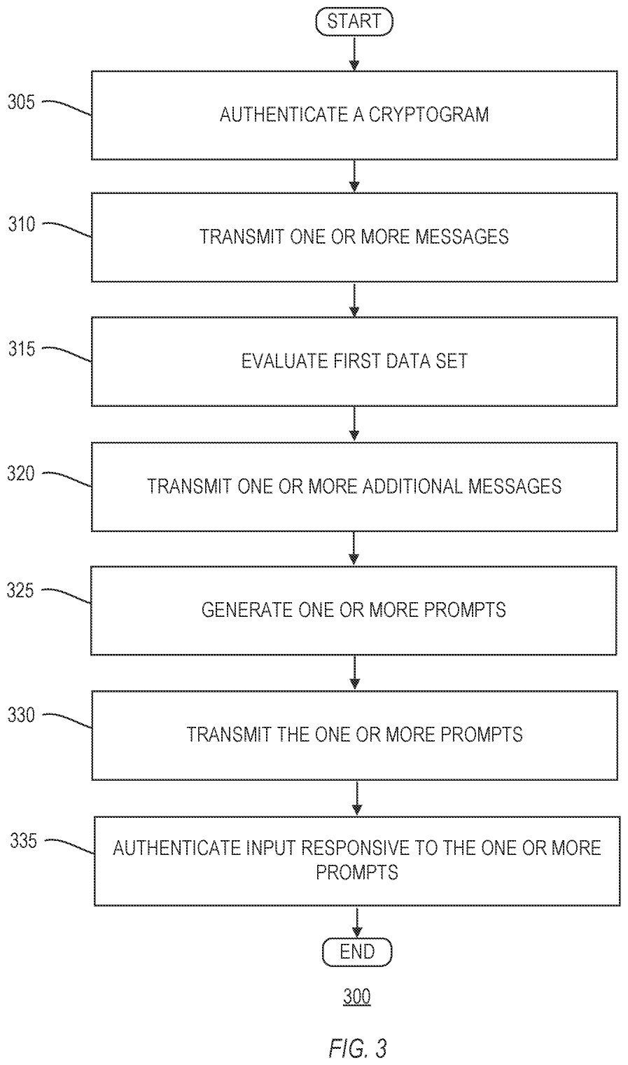

FIG. 3 depicts a method 300 of authentication. FIG. 3 may reference the same or similar components of system 100, and first device 200 of FIG. 2A and FIG. 2B.

At block 305, the method 300 may include authenticating a cryptogram. For example, the cryptogram may be authenticated as part of a first factor authentication. In some examples, an application comprising instructions for execution on a device may be configured to perform the first factor authentication. In other examples, a server may be configured to perform the first factor authentication. For example, the application of the client device may be configured to conduct one or more reads of a card as part of a first factor authentication. For example, the application may be configured to conduct a read, such as a near field communication read, of a tag, such as a near field communication tag, of the card. The card may be configured to transmit a cryptogram. For example, the card may be configured to transmit, after entry into one or more communication fields of any device, data responsive to the read, such as a first read, via a communication interface of the card. In some examples, the card may be configured to transmit, after a first entry into a first communication field of the device, the cryptogram. Without limitation, each entry may be associated with a tap, a swipe, a wave, and/or any combination thereof. The application of the client device may be configured to receive the cryptogram transmitted by the card. The cryptogram may be generated based on a first read of the tag of the card. For example, the cryptogram may be obtained via a near field communication data exchange format (NDEF) read. In some examples, the card may be configured to encrypt the cryptogram prior to its transmission.

The application of the client device may be configured to transmit the cryptogram that it received from the card to a server. In some examples, the server may be configured to receive the cryptogram transmitted by the card. The server may be configured to decrypt the cryptogram as part of the first factor authentication. In other examples, the application of the client device may be configured to decrypt the cryptogram as part of the first factor authentication.

At block 310, the method 300 may include transmitting one or more messages. For example, the server may be configured to transmit one or more messages to the application of the client device. For example, one of the messages may comprise an indication of authentication status of the cryptogram. For example, the server may be configure to transmit a message to the application of the client device that is indicative of authentication validation, such as a successful authentication status of the cryptogram. To the extent that the server is unable to authenticate the cryptogram, the server may be configured to transmit a message indicative of an unsuccessful authentication status of the cryptogram. If the cryptogram is not successfully authenticated, the server may be configured to instruct, via one or more commands, the client application of the client device to re-read the tag of the card to receive the cryptogram. In this manner, the server may be configured to decrypt the cryptogram as part of the first factor authentication. In some examples, the server may be configured to transmit one or more messages that are instructive of performing a second factor authentication.

At block 315, the method 300 may include evaluating a first data set. For example, the application of the device may be configured to receive the one or more messages from the server. The application of the device may be configured to perform, after the first factor authentication, another read. For example, the application of the device may be configured to perform a second read of the card. The card may be configured to transmit, after the second read, a first data set. For example, the first data set may be obtained via the second read, such as a near field communication data exchange format (NDEF) read. The first data set may be transmitted by the card to the application of the client device via the second read. The first data set may comprise one or more sets of prior data. Without limitation, the first data set may include data for the last three transactions, such as an identifier associated with the first data set, a type of first data set, method of entry into the communication field, time stamp, and amount. The second read may be associated with one or more gestures, including but not limited to a tap, a swipe, or a wave, that represent any number of entries of a communication interface of the card into a communication field of the device.

The application of the client device may be configured to perform a second factor authentication. For example, the one or more sets of prior data may be evaluated against one or more reference sets of prior data as part of the second factor authentication. In other examples, the application of the client device may be configured to transmit the data to the server for evaluation as part of the second factor authentication.

At block 320, the method 300 may include transmitting one or more additional messages. For example, the application of the client device may be configured to generate an outcome of the second factor authentication by comparing the one or more sets of prior data to one or more reference sets of prior data. Based on the outcome of the second factor authentication, the application of the client device may be configured to generate and display one or more additional messages that are indicative of the outcome of the second factor authentication. In other examples, the server may be configured to generate and transmit one or more additional messages that are indicative of the outcome of the second factor authentication. In addition, prior to performance of a second factor authentication, the application of the client device, or server, may be configured to extract metadata from the first data set. The metadata may be extracted from the first device. In some examples, the second factor authentication may include authentication of metadata. For example, the second factor authentication may comprise authentication of metadata of the card. In some examples, the metadata belonging to the first device may be personalized at the time of creation of the first device, for example by the issuer. The metadata of the first device may be customized such that it is populated to include, without limitation, a plurality of fields comprising one or more prior transactions (including merchant and transaction data for a predetermined number of transactions, such as five transactions), one or more transaction date and time stamps, one or more phone numbers, one or more addresses, and/or combination thereof and/or any other personally identifiable information that is capable of being authenticated. In some examples, the mobile phone number associated with the user or account may be read from the first device, and a second factor authentication may be transmitted to the application of client device. For example, the second factor authentication may comprise a short message system one-time password received by application of the client device.

At block 325, the method 300 may include generating one or more prompts. For example, the server may be configured to generate one or more prompts. In other examples, the application of the device may be configured to generate one or more prompts. The application of the client device may be configured to perform a third factor authentication. The third factor authentication may be performed prior to conversion of a first type of operation to a second type of operation by the application of the client device. In other examples, the server or application of the client device may be configured to generate, transmit and/or receive one or more messages indicative of the outcome of the second factor authentication. For example, at least one of the messages may be configured to instruct the application or server to effectuate one or more actions. The one or more actions may include conversion of the first type of operation to a second type of operation. For example, the first type of operation may comprise a card-not-present transaction. The second type of operation may comprise a card-present transaction. In this manner, the conversion may allow for improved security by indicating that the card was present for performing one or more operations, such as capturing a communication with card readers, contactless or contact-enabled terminals. In this manner, the conversion from the first type of operation to the second type of operation may be dependent on the outcome, such as the successful outcome, of the second factor authentication, since the first device will be have been proven to be in physical possession of the user, thereby distinguishing between a card-present transaction and a card-not-present transaction. Moreover, the third factor authentication may be performed after the second factor authentication. For example, the application of the client device may be configured to perform the third factor authentication by generating one or more prompts that are transmitted via one or more notifications. In some examples, the third factor authentication may be performed by prompting, via the one or more notifications, input that is responsive to one or more queries.

Without limitation, the one or more queries may include at least one selected from the group of a primary account number, cardholder identifier such as first name, middle name, last name, a type of operation, a date, a nationality of the cardholder, a cardholder language, an address, a date of birth, an email, a telephone number, an expiration date, a credit card number, a debit card number, and/or any combination thereof. Moreover, the one or more queries may include a request for a partial portion, including but not limited to a redacted portion, of any number of these queries. The one or more queries may resemble knowledge-based authentication that form the basis of the third factor authentication.

At block 330, the method 300 may include transmitting the one or more prompts. In some examples, the server may be configured to transmit the one or more prompts. For example, the server may be configured to transmit the one or more prompts to the application of the device.

At block 335, the method 300 may include authenticating input responsive to the one or more queries. For example, the server may be configured to receive input responsive to the one or more queries. In another example, the application may be configured to receive input that is responsive to the one or more queries. For example, the application of the client device may be configured to transmit the received input to the server for authentication. The application of the device may be configured to authenticate the received input responsive to the one or more queries by comparing reference input to the received input. After successfully authenticating the input, for example, by the application of the client device or the server, the application of the client device or the server may be configured to convert a first type of operation to a second type of operation. The third factor authentication may be performed prior to conversion of a first type of operation to a second type of operation by the application of the client device. In other examples, the server or application of the client device may be configured to generate, transmit and/or receive one or more messages indicative of the outcome of the second factor authentication. For example, at least one of the messages may be configured to instruct the application or server to effectuate one or more actions. The one or more actions may include conversion of the first type of operation to a second type of operation. For example, the first type of operation may comprise a card-not-present transaction. The second type of operation may comprise a card-present transaction. In this manner, the conversion may allow for improved security by indicating that the card was present for performing one or more operations, such as capturing a communication with card readers, contactless or contact-enabled terminals. In this manner, the conversion from the first type of operation to the second type of operation may be dependent on the outcome, such as the successful outcome, of the second factor authentication, since the first device will be have been proven to be in physical possession of the user, thereby distinguishing between a card-present transaction and a card-not-present transaction. In some examples, the application of the client device may be configured to receive and authenticate the input via one or more responses that are responsive to the queries posed in the one or more prompts. In other examples, the application of the client device may be configured to transmit input that it received via one or more responses that are responsive to the queries posed in the one or prompts to a server for authentication. The server may be configured to transmit the received input to a database for authentication of the input and conversion of the transaction.

The application of the client device or the server may be configured to receive input that is responsive to the one or more queries. For example, the input to the one or more queries may include a response that includes an answer as to how many times the user shopped at a particular merchant, or conducted an operation with a specified reader or terminal, within a time frame. In another example, the input to the one or more queries may include a response that includes an answer as to how many items were associated with the most recent purchase. In another example, the input to the one or more queries may include a response that includes an amount spent associated with the most recent purchase. In another example, the input to the one or more queries may include a response that includes an answer as to a location and/or an identity of the last two transactions.

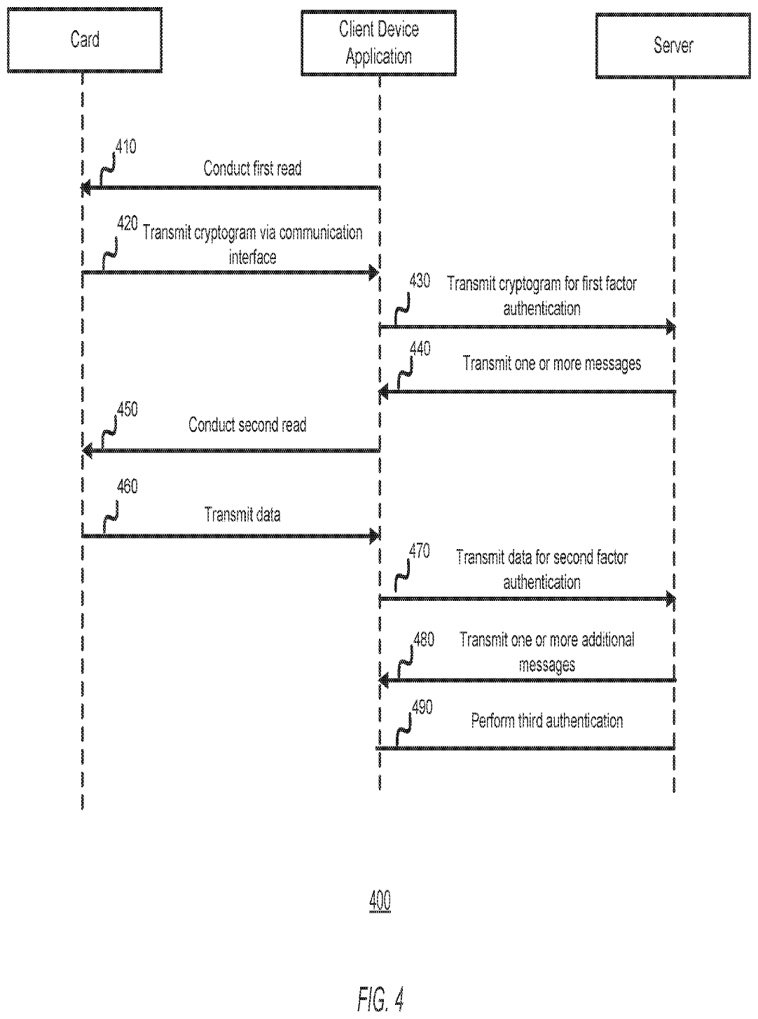

FIG. 4 depicts a sequence diagram 400 of an authentication process according to an exemplary embodiment. FIG. 4 may reference the same or similar components of system 100, first device 200 of FIG. 2A and FIG. 2B, and method 300 of FIG. 3.

At step 410, an application of a client device may be configured to conduct one or more reads of a card as part of a first factor authentication. For example, the application may be configured to conduct a read, such as a near field communication read, of a tag, such as a near field communication tag, of the card.

At step 420, the card may be configured to transmit a cryptogram. The card may be configured to transmit, after entry into one or more communication fields of any device, data responsive to the read, such as a first read, via a communication interface of the card. For example, the card may be configured to transmit, after a first entry into a first communication field of the device, the cryptogram. Without limitation, each entry may be associated with a tap, a swipe, a wave, and/or any combination thereof. The application of the client device may be configured to receive the cryptogram transmitted by the card. The cryptogram may be generated based on a first read of the tag of the card. For example, the cryptogram may be obtained via a near field communication data exchange format (NDEF) read. In some examples, the card may be configured to encrypt the cryptogram prior to its transmission.

At step 430, the application of the client device may be configured to transmit the cryptogram that it received from the card to a server. In some examples, the server may be configured to receive the cryptogram transmitted by the card. The server may be configured to decrypt the cryptogram as part of the first factor authentication. In other examples, the application of the client device may be configured to decrypt the cryptogram as part of the first factor authentication.

At step 440, the server may be configured to transmit one or more messages to the application of the client device. For example, one of the messages may comprise an indication of authentication status of the cryptogram. For example, the server may be configure to transmit a message to the application of the client device that is indicative of authentication validation, such as a successful authentication status of the cryptogram. To the extent that the server is unable to authenticate the cryptogram, the server may be configured to transmit a message indicative of an unsuccessful authentication status of the cryptogram. If the cryptogram is not successfully authenticated, the server may be configured to instruct, via one or more commands, the client application of the client device to re-read the tag of the card to receive the cryptogram. In this manner, the server may be configured to decrypt the cryptogram as part of the first factor authentication.

At step 450, the application of the device may be configured to receive the one or more messages from the server. The application of the device may be configured to perform, after the first factor authentication, another read. For example, the application of the device may be configured to perform a second read of the card.

At step 460, the card may be configured to transmit, after the second read, data such as a first data set. For example, the first data set may be obtained via a second near field communication data exchange format (NDEF) read. The first data set may be transmitted by the card to the processor via the read. The first data set may comprise one or more sets of prior data. Without limitation, the first data set may include data for the last three transactions, such as an identifier associated with the first data set, a type of first data set, method of entry into the communication field, time stamp, and amount. The second read may be associated with one or more gestures, including but not limited to a tap, a swipe, or a wave, that represent any number of entries of a communication interface of the card into a communication field of the device.

At step 470, the application of the client device may be configured to perform a second factor authentication. For example, the one or more sets of prior data may be evaluated against one or more reference sets of prior data as part of the second factor authentication. In other examples, the application of the client device may be configured to transmit the first data set to the server for evaluation as part of the second factor authentication. For example, the server may be configured to perform the second factor authentication of the first data set by generating an outcome of the second factor authentication by comparing the one or more sets of prior data to one or more reference sets of prior data. The reference sets of prior data may be stored in the server. In other example, the one or more reference sets of prior data may be accessible by the server and retrieved from a database. In other examples, the application of the client device may be configured to generate an outcome of the second factor authentication by comparing the one or more sets of prior data to one or more reference sets of prior data. Based on the outcome of the second factor authentication, the application of the client device may be configured to generate and display one or more messages that are indicative of the outcome of the second factor authentication.

At step 480, the server may be configured to transmit one or more additional messages indicative of the outcome of the second factor authentication of the first data set. The server may be configured to instruct, via the one or more additional messages, the application of the client device to perform the second factor authentication.

At step 490, the application of the client device may be configured to perform a third factor authentication. The third factor authentication may be performed prior to conversion of a first type of operation to a second type of operation by the application of the client device. In other examples, the server or application of the client device may be configured to generate, transmit and/or receive one or more messages indicative of the outcome of the second factor authentication. For example, at least one of the messages may be configured to instruct the application or server to effectuate one or more actions. The one or more actions may include conversion of the first type of operation to a second type of operation. For example, the first type of operation may comprise a card-not-present transaction. The second type of operation may comprise a card-present transaction. In this manner, the conversion may allow for improved security by indicating that the card was present for performing one or more operations, such as capturing a communication with card readers, contactless or contact-enabled terminals. In this manner, the conversion from the first type of operation to the second type of operation may be dependent on the outcome, such as the successful outcome, of the second factor authentication, since the first device will be have been proven to be in physical possession of the user, thereby distinguishing between a card-present transaction and a card-not-present transaction. Moreover, the third factor authentication may be performed after the second factor authentication. In other examples, the server may be configured to perform the third factor authentication. In some examples, the server may be configured to instruct the application of the client device to perform the third factor authentication. For example, the application of the client device may be configured to perform the third factor authentication by generating one or more prompts that are transmitted via one or more notifications. In some examples, the third factor authentication may be performed by prompting, via the one or more notifications, input that is responsive to one or more queries.

Without limitation, the one or more queries may include at least one selected from the group of a primary account number, cardholder identifier such as first name, middle name, last name, a type of operation, a date, a nationality of the cardholder, a cardholder language, an address, a date of birth, an email, a telephone number, an expiration date, a credit card number, a debit card number, and/or any combination thereof. Moreover, the one or more queries may include a request for a partial portion, including but not limited to a redacted portion, of any number of these queries. The one or more queries may resemble knowledge-based authentication that form the basis of the third factor authentication.

The application of the client device may be configured to receive input that is responsive to the one or more queries. For example, the input to the one or more queries may include a response that includes an answer as to how many times the user shopped at a particular merchant, or conducted an operation with a specified reader or terminal, within a time frame. In another example, the input to the one or more queries may include a response that includes an answer as to how many items were associated with the most recent purchase. In another example, the input to the one or more queries may include a response that includes an amount spent associated with the most recent purchase. In another example, the input to the one or more queries may include a response that includes an answer as to a location and/or an identity of the last two transactions.

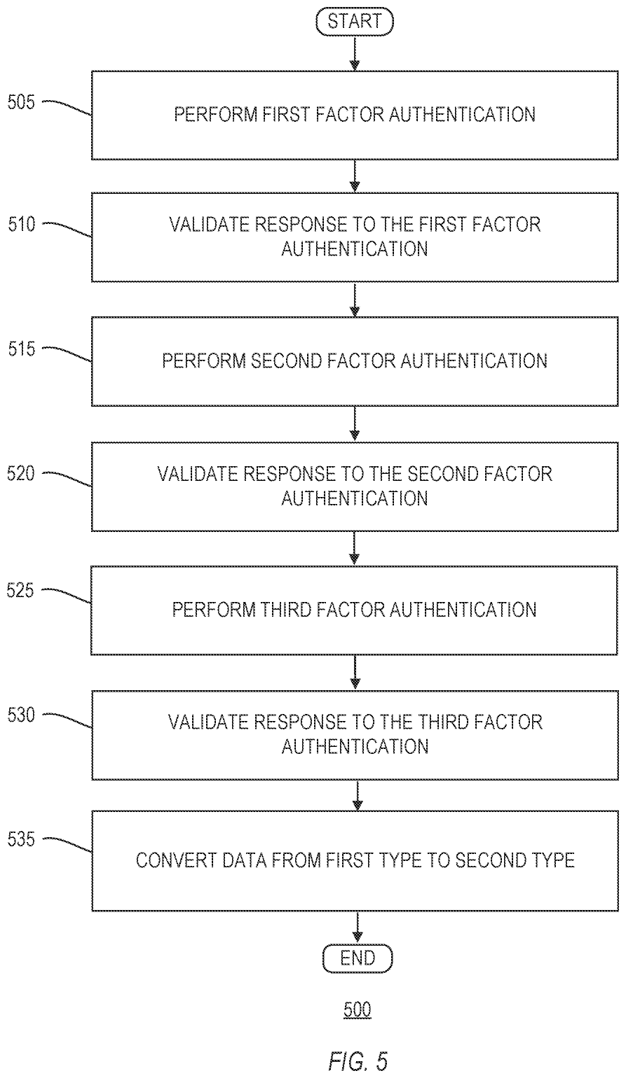

FIG. 5 depicts a method of 500 of authentication according to an exemplary embodiment. FIG. 5 may reference the same or similar components of system 100, first device 200 of FIG. 2A and FIG. 2B, method 300 of FIG. 3, and sequence diagram 400 of FIG. 4.

At block 505, the method 500 may include performing a first factor authentication. For example, an application of a client device may be configured to perform a first factor authentication. In other examples, a server may be configured to perform a first factor authentication. The application of the client device may be configured to conduct one or more reads of a card as part of a first factor authentication. For example, the application may be configured to conduct a read, such as a near field communication read, of a tag, such as a near field communication tag, of the card.

At block 510, the method 500 may include validating a response to the first factor authentication. In some examples, the application of the client device may be configured to receive a response to the first factor authentication. The response may include a cryptogram. The application of the client device may be configured to validate the response to the first factor authentication. The card may be configured to transmit, via a response, a cryptogram. The card may be configured to transmit, after entry into one or more communication fields of any device, data responsive to the read, such as a first read, via a communication interface of the card. For example, the card may be configured to transmit, after a first entry into a first communication field of the device, the cryptogram. Without limitation, each entry may be associated with a tap, a swipe, a wave, and/or any combination thereof. The application of the client device may be configured to receive the cryptogram transmitted by the card. The cryptogram may be generated based on a first read of the tag of the card. For example, the cryptogram may be obtained via a near field communication data exchange format (NDEF) read. In some examples, the card may be configured to encrypt the cryptogram prior to its transmission. In some examples, the application of the client device may be configured to decrypt the cryptogram as part of the first factor authentication.

In other examples, the server may be configured to receive a response to the first factor authentication. The application of the client device may be configured to transmit the cryptogram that it received from the card to a server. In some examples, the server may be configured to receive the cryptogram transmitted by the card. The server may be configured to decrypt the cryptogram as part of the first factor authentication.

At block 515, the method 500 may include performing a second factor authentication. For example, the application of the client device may be configured to perform a second factor authentication. The application of the device may be configured to perform, after the first factor authentication, another read. For example, the application of the device may be configured to perform a second read of the card. The card may be configured to transmit, after the second read, data such as a first data set. For example, the first data set may be obtained via a second near field communication data exchange format (NDEF) read. The first data set may be transmitted by the card to the processor via the second read. The second read may be associated with one or more gestures, including but not limited to a tap, a swipe, or a wave, that represent any number of entries of a communication interface of the card into a communication field of the device.

In other examples, a server may be configured to perform a second factor authentication. For example, the server may be configured to transmit one or more messages to the application of the client device that indicates instruction of performance of the second factor authentication by the application of the client device or by the server.

At block 520, the method 500 may include validating a response to the second factor authentication. In some examples, the application of the client device may be configured to receive a response to the second factor authentication. For example, the application of the client device may be configured to receive a response including the first data set to the second factor authentication. The first data set may comprise one or more sets of prior data. Without limitation, the first data set may include data for the last three transactions, such as an identifier associated with the first data set, a type of first data set, method of entry into the communication field, time stamp, and amount.

The application of the client device may be configured to validate the response to the second factor authentication. For example, the one or more sets of prior data may be evaluated against one or more reference sets of prior data as part of the second factor authentication. In other examples, the application of the client device may be configured to generate an outcome of the second factor authentication by comparing the one or more sets of prior data to one or more reference sets of prior data. Based on the outcome of the second factor authentication, the application of the client device may be configured to generate and display one or more messages that are indicative of the outcome of the second factor authentication.

In other examples, the server may be configured to receive a response to the second factor authentication. For example, the server may be configured to validate the response to the second factor authentication. The application of the client device may be configured to transmit the first data set to the server for evaluation as part of the second factor authentication. For example, the server may be configured to perform the second factor authentication of the first data set by generating an outcome of the second factor authentication by comparing the one or more sets of prior data to one or more reference sets of prior data. The reference sets of prior data may be stored in the server. In other example, the one or more reference sets of prior data may be accessible by the server and retrieved from a database.

At block 525, the method 500 may include performing a third factor authentication. For example, the application of a client device may be configured to perform a third factor authentication. The third factor authentication may be performed prior to conversion of a first type of operation to a second type of operation by the application of the client device. In other examples, the server or application of the client device may be configured to generate, transmit and/or receive one or more messages indicative of the outcome of the second factor authentication. For example, at least one of the messages may be configured to instruct the application or server to effectuate one or more actions. The one or more actions may include conversion of the first type of operation to a second type of operation. For example, the first type of operation may comprise a card-not-present transaction. The second type of operation may comprise a card-present transaction. In this manner, the conversion may allow for improved security by indicating that the card was present for performing one or more operations, such as capturing a communication with card readers, contactless or contact-enabled terminals. In this manner, the conversion from the first type of operation to the second type of operation may be dependent on the outcome, such as the successful outcome, of the second factor authentication, since the first device will be have been proven to be in physical possession of the user, thereby distinguishing between a card-present transaction and a card-not-present transaction. Moreover, the third factor authentication may be performed after the second factor authentication. For example, the application of the client device may be configured to perform the third factor authentication by generating one or more prompts that are transmitted via one or more notifications. In some examples, the third factor authentication may be performed by prompting, via the one or more notifications, input that is responsive to one or more queries.

Without limitation, the one or more queries may include at least one selected from the group of a primary account number, cardholder identifier such as first name, middle name, last name, a type of operation, a date, a nationality of the cardholder, a cardholder language, an address, a date of birth, an email, a telephone number, an expiration date, a credit card number, a debit card number, and/or any combination thereof. Moreover, the one or more queries may include a request for a partial portion, including but not limited to a redacted portion, of any number of these queries. The one or more queries may resemble knowledge-based authentication that form the basis of the third factor authentication.

In other examples, the server may be configured to perform the third factor authentication. In some examples, the server may be configured to instruct the application of the client device to perform the third factor authentication.

At block 530, the method 500 may include validating a response to the third factor authentication. For example, the application of the client device may be configured to receive input that is responsive to the one or more queries. The application of the device may be configured to authenticate the received input responsive to the one or more queries by comparing reference input to the received input. In some examples, the application of the client device may be configured to receive a response to the third factor authentication. For example, the application of the client device may be configured to validate the response to the third factor authentication. The application of the client device may be configured to receive input that is responsive to the one or more queries. For example, the input to the one or more queries may include a response that includes an answer as to how many times the user shopped at a particular merchant, or conducted an operation with a specified reader or terminal, within a time frame. In another example, the input to the one or more queries may include a response that includes an answer as to how many items were associated with the most recent purchase. In another example, the input to the one or more queries may include a response that includes an amount spent associated with the most recent purchase. In another example, the input to the one or more queries may include a response that includes an answer as to a location and/or an identity of the last two transactions.

In other examples, the server may be configured to receive a response to the third factor authentication. For example, the server may be configured to validate the response to the third factor authentication. The server may be configured to validate the input for the third factor authentication.

At block 535, the method 500 may include converting data from a first type to a second type. After successfully authenticating the input, for example, by the application of the client device or the server, the application of the client device or the server may be configured to convert a transaction from a card-not-present transaction to card-present transaction, the transaction associated with the first data set. In some examples, the application of the client device may be configured to receive and authenticate the input via one or more responses that are responsive to the queries posed in the one or more prompts. In other examples, the application of the client device may be configured to transmit input that it received via one or more responses that are responsive to the queries posed in the one or prompts to a server for authentication. The server may be configured to transmit the received input to a database for authentication of the input and conversion of the transaction.

The application of the client device or the server may be configured to receive input that is responsive to the one or more queries. For example, the input to the one or more queries may include a response that includes an answer as to how many times the user shopped at a particular merchant, or conducted an operation with a specified reader or terminal, within a time frame. In another example, the input to the one or more queries may include a response that includes an answer as to how many items were associated with the most recent purchase. In another example, the input to the one or more queries may include a response that includes an amount spent associated with the most recent purchase. In another example, the input to the one or more queries may include a response that includes an answer as to a location and/or an identity of the last two transactions. In another example, the application of the client device may be configured to transmit the received input to the server for authentication.

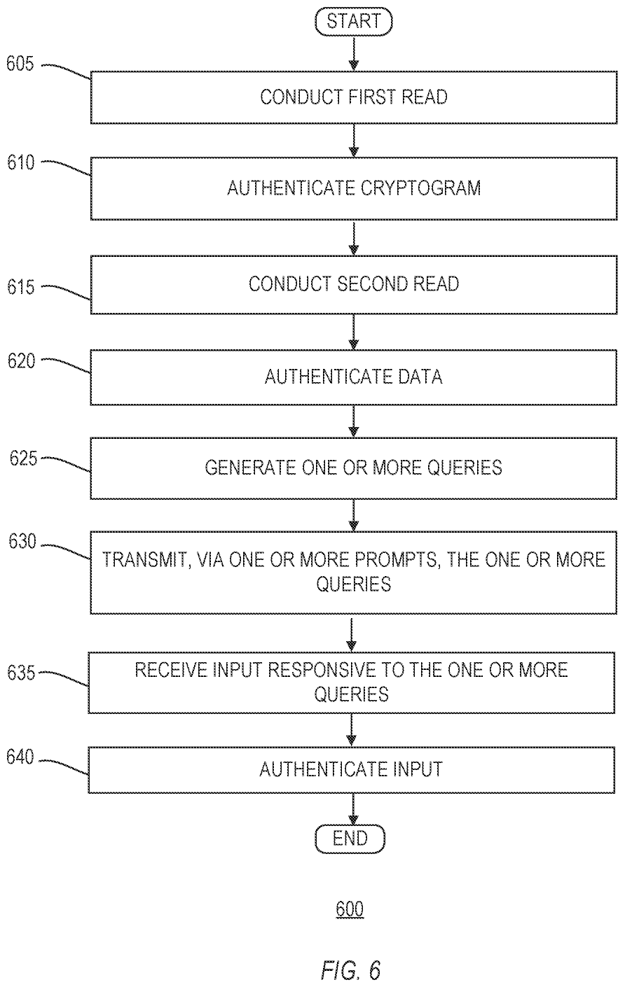

FIG. 6 depicts an authentication method 600 according to an exemplary embodiment. FIG. 6 may reference the same or similar components of system 100, first device 200 of FIG. 2A and FIG. 2B, method 300 of FIG. 3, sequence diagram 400 of FIG. 4, and method 500 of FIG. 5.

At block 605, the method 600 may include conducting a first read. For example, the first read may be conducted by an application of a device. The device may include one or more processors. The device may include a memory. The device may include an application comprising instructions for execution thereon.

At block 610, the method 600 may include authenticating a cryptogram. The processor may be configured to perform a first factor authentication. In some examples, the first factor authentication may comprise authenticating a cryptogram. For example, the cryptogram may be obtained via a near field communication data exchange format (NDEF) read. The first read of a tag of a card may yield the cryptogram.

At block 615, the method 600 may include conducting a second read. For example, after the first factor authentication, the processor may be configured to perform another read, such as a second read. In some examples, the read performed after the first factor authentication may comprise an NDEF read.

At block 620, the method 600 may include authenticating data. For example, the second read may yield data, such as a first dataset. The first data set may be transmitted by the card to the processor via the read. The first data set may comprise one or more sets of prior data. Without limitation, the first data set may include data for the last three transactions, such as an identifier associated with the first data set, a type of first data set, method of entry into the communication field, time stamp, and amount. The read may be associated with one or more gestures, including but not limited to a tap, a swipe, or a wave, that represent any number of entries of a communication interface of the card into a communication field of the device.

The first data set may be transmitted by the processor for another factor of authentication, such as a second factor authentication. For example, the processor may be configured to transmit the first data set to a server. In some examples, the processor may be configured to transmit the first data set for a second factor authentication. For example, the one or more sets of prior data may be evaluated against one or more reference sets of prior data. The processor may be configured to generate an outcome of the second factor authentication by comparing the one or more sets of prior data to one or more reference sets of prior data. Based on the outcome of the second factor authentication, the processor may be configured to transmit one or more messages that are indicative of the outcome of the second factor authentication.

In another example, the server may be configured to generate an outcome of the second factor authentication by comparing the one or more sets of prior data to one or more reference sets of prior data. The processor may be configured to receive one or more messages indicative of an outcome of the second factor authentication. For example, the processor may be configured to receive, from the server, a message that is indicative of authentication validation, such as a successful outcome of the second factor authentication. In another example, the processor may be configured to receive, from the server, a message that is indicative of an unsuccessful outcome of the second factor authentication. To the extent that the processor is configured to receive a message that is indicative of the unsuccessful outcome of the second factor authentication, the processor may be configured to re-transmit the first data set for second factor authentication. For example, the processor may be configured to retransmit the first data set for second factor authentication up to and including a predetermined number corresponding to a threshold. After the threshold has been reached, the processor may be configured to halt the authentication process. In another example, to the extent that the processor is configured to receive a message that is indicative of the unsuccessful outcome of the second factor authentication, the processor may be configured to halt the authentication process.

Prior to performance of a second factor authentication, the application of the client device, or server, may be configured to extract metadata from the first data set. The metadata may be extracted from the first device. In some examples, the second factor authentication may include authentication of metadata. For example, the second factor authentication may comprise authentication of metadata of the first device. In some examples, the metadata belonging to the first device may be personalized at the time of creation of the first device, for example by the issuer. The metadata of the first device may be customized such that it is populated to include, without limitation, a plurality of fields comprising one or more prior transactions (including merchant and transaction data for a predetermined number of transactions, such as five transactions), one or more transaction date and time stamps, one or more phone numbers, one or more addresses, and/or combination thereof and/or any other personally identifiable information that is capable of being authenticated. In some examples, the mobile phone number associated with the user or account may be read from the first device, and a second factor authentication may be transmitted to the application of client device. For example, the second factor authentication may comprise a short message system one-time password received by application of the client device.

After receipt of the message that is indicative of the outcome of the second factor authentication, the processor may be configured to convert a transaction from a card-not-present transaction to a card-present transaction. In some examples, the transaction may be associated with the transaction data.

At block 625, the method 600 may include generate one or more queries. For example, the processor may be configured to perform a third factor authentication. The third factor authentication may be performed prior to conversion of a first type of operation to a second type of operation by the application of the client device. In other examples, the server or application of the client device may be configured to generate, transmit and/or receive one or more messages indicative of the outcome of the second factor authentication. For example, at least one of the messages may be configured to instruct the application or server to effectuate one or more actions. The one or more actions may include conversion of the first type of operation to a second type of operation. For example, the first type of operation may comprise a card-not-present transaction. The second type of operation may comprise a card-present transaction. In this manner, the conversion may allow for improved security by indicating that the card was present for performing one or more operations, such as capturing a communication with card readers, contactless or contact-enabled terminals. In this manner, the conversion from the first type of operation to the second type of operation may be dependent on the outcome, such as the successful outcome, of the second factor authentication, since the first device will be have been proven to be in physical possession of the user, thereby distinguishing between a card-present transaction and a card-not-present transaction. For example, the processor may be configured to perform the third factor authentication by generating one or more prompts that are transmitted via one or more notifications. In some examples, the third factor authentication may be performed by prompting, via the one or more notifications, input that is responsive to one or more queries.

Without limitation, the one or more queries may include at least one selected from the group of a primary account number, cardholder identifier such as first name, middle name, last name, a type of operation, a date, a nationality of the cardholder, a cardholder language, an address, a date of birth, an email, a telephone number, an expiration date, a credit card number, a debit card number, and/or any combination thereof. Moreover, the one or more queries may include a request for a partial portion, including but not limited to a redacted portion, of any number of these queries. The one or more queries may resemble knowledge-based authentication that form the basis of the third factor authentication.

In other examples, the query may include a question requesting how many times has the user shopped at a particular merchant, or conducted an operation with a specified reader or terminal, within a time frame. In another example, the query may include a question requesting how many items were associated with the most recent purchase. In another example, the query may include a question requesting an amount spent associated with the most recent purchase. In another example, the query may include a question requesting a location and/or identity of the last two transactions.

At block 630, the method 600 may include transmitting, via one or more prompts, the one or more queries. For example, the processor may be configured to transmit the one or more queries. In another example, the server may be configured to transmit the one or more queries.

In some examples, the prompt for input for a response to the one or more queries may be time-restricted. For example, the prompt for input may be configured to expire after a predetermined time, including but not limited to seconds, minutes, hours, etc. In another example, the one or more processors may be configured to prompt, after expiration of the predetermined time, additional input that is responsive to the one or more queries. In some examples, the additional input that is responsive to the one or more queries may be different from the input that is initially requested that is responsive to the one or more queries. Thus, the initial set of one or more queries may be different from the additional set of one or more queries.

For example, the processor may be configured to request a middle name of the user via one or more prompts. If no input is received or provided within 10 seconds, the expiration time for input responsive to this query may expire after 10 seconds, and another prompt for input responsive to another query may be generated and transmitted. For example, the processor may be configured to request the last four digits of the primary account number, in which the input must be provided within 15 seconds. In some examples, the predetermined time associated with the additional queries may be different than the predetermined time associated with the initial queries. In other examples, the predetermined time associated with the additional queries may be the same as the predetermined time associated with the initial queries.

In another example, the processor may be configured to generate and transmit a prompt requiring, within 5 seconds, input of the nationality of the user. If no input is received or provided within the 5 seconds, the expiration time for input responsive to the query may expire after 5 seconds, and another prompt for input responsive to another query may be generated and transmitted. For example, the processor may be configured to request the location of the most recent transaction, and whether the transaction was associated with a credit or debit card, in which the input must be provided within 10 seconds.

In some examples, the prompt for input may be associated with a threshold number of the one or more queries. For example, the prompt for input may be associated with any number, such as two queries. After exhaustion of the number of queries, the processor may be configured to determine whether to authenticate the input based on the response input associated with the prompt of the queries. Using the above example, after exhaustion of two queries, the processor may be configured to terminate the received input that is responsive to the queries if it determines that the input is incorrect.

At block 635, the method 600 may include receiving input responsive to the one or more queries. For example, the processor may be configured to receive the input responsive to the one or more queries. In another example, the server may be configured to receive input responsive to the one or more queries.

At block 640, the method 600 may include authenticating the input. For example, the processor may be configured to authenticate, after receipt of the input, the input that is responsive to the one or more queries. In another example, the server may be configured to authenticate, after receipt of the input, the input that is responsive to the one or more queries.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. An authentication server, comprising:
a memory; and
a processor configured to:
receive a cryptogram associated with a first near field communication data exchange format (NDEF) read;
perform a first factor authentication of the cryptogram;
receive a first data set, wherein the first data set is associated with a second NDEF read;
extract metadata from the first data set;
perform, after the first factor authentication, a second factor authentication based on the metadata;
generate a message indicative of an outcome of the second factor authentication; and
transmit the message that instructs the processor to effectuate one or more actions.
